(19) United States
(12) Patent Application Publication
(10) Pub. No.: US 2003/0156539 A1
(43) Pub. Date: Aug. 21, 2003

(54) Method and device with improved channel equalization for mobile radio communications

(76) Inventors: Peter Bohnhoff, Munchen (DE); Bin Yang, Stuttgart (DE)

Correspondence Address: LERNER AND GREENBERG, P.A., POST OFFICE BOX 2480, HOLYWOOD, FL, 33022-2480, US

(21) Appl. No.: 10/382,193

(22) Filed: Mar. 5, 2003

Related U.S. Application Data
(63) Continuation of application No. PCT/DE01/03390, filed on Aug. 30, 2001.

(30) Foreign Application Priority Data
Sep. 5, 2000 (DE) 100 43 742.7

(51) Int. Cl. H04L 1/00

(52) U.S. Cl. 370/231; 370/337

(57) ABSTRACT

A receiver unit for mobile radio transmission has a channel estimator and a channel equalizer. In addition to the first six channel coefficients, the channel estimator determines with the aid of the training sequence further channel coefficients that are then used to equalize the received data symbols. Although the training sequence is designed in the GSM standard only for determining six channel coefficients, the decoding is greatly improved.

### CROSS-REFERENCE TO RELATED APPLICATION

This application is a continuation of copending International Application. No. PCT/DE01/03390, filed Aug. 30, 2001, which designated the United States and which was not published in English.

### BACKGROUND OF THE INVENTION

Field of the Invention

The invention lies in the communications field. More specifically, the invention relates to a receiver unit for mobile radio transmission that has a channel estimator and a channel equalizer, and to a method for equalizing data symbols transmitted via a mobile radio channel.

In mobile radio transmission the overall bit error rate is substantially determined by three error sources. One error source is the noise that is superimposed on the actual useful signal and which renders decoding difficult. Moreover, the so-called frequency error causes a contribution to the overall bit error rate. The error caused by frequency detuning between the transmitter and receiver is designated as frequency error, this frequency detuning possibly being caused by the Doppler effect, for example.

Channel distortion may be named as a further error source. The transmitted signal passes on various paths to the receiver and is differentially delayed by these various paths. A superimposition of differentially delayed signal components, so-called intersymbol interference (ISI), then occurs at the receiver end. Attempts are made at the receiving end to remove the intersymbol interference by estimating the channel response and equalization of the received signal. However, such equalization succeeds only in part, and therefore the intersymbol interference contributes to the overall bit error.

In the GSM mobile radio standard (GSM, Global System for Mobile Communications), the signal-to-noise ratio is less than 10 dB. To this extent, noise is the dominant error source here. The GMSK modulation (GMSK, Gaussian Minimum Shift Keying) used in the GSM standard uses a signal space with the signal points +1 and −1. Since these two signal points have a phase difference of 180°, GSM is relatively robust against disturbances such as are caused, for example, by residual errors in the intersymbol interference removed. GPRS (General Packet Radio Service) operates with a higher signal-to-noise ratio of more than 15 dB. Data transmission rates of up to 21.4 kbit/s are rendered possible in this way. Here, noise occurs as an error source in the background and to this extent more importance attaches to combating the errors caused by ISI.

The EDGE (Enhanced Data Rates for GSM Evolution) standard and the associated EGPRS (Enhanced GPRS) packet service have been defined as transition standard between GSM/GPRS and UMTS. EDGE is a TDMA (Time Division Multiple Access) method, but a transition is already being made from the GMSK modulation to the 8-PSK modulation (PSK, phase shift keying). The 8-PSK modulation uses a signal space with eight signal points, the phase difference between the individual signal points being 45°. Even small errors in the equalization of the received signals lead here to defective decoding of the received data symbols, and thus to a rise in the bit error rate. To this extent, the 8-PSK modulation standard is substantially more vulnerable to the errors caused by ISI than was the case with the precursor GMSK standard.

It is therefore becoming ever more important to provide suitable measures for combating the contribution to the bit error rate caused by ISI.

U.S. Pat. No. 5,185,764 describes a receiver that measures a specific number of channel parameters by means of a channel estimator and uses the measured channel parameters for equalizing a received signal.

The use of five or six channel parameters for equalizing a signal is described in the article entitled “Bit Synchronization and Timing Sensitivity in Adaptive Viterbi Equalizers for Narrowband-TDMA Digital Mobile Radio Systems” by A. Baier et al., Philips Kommunikations Industrie AG, Germany, pages 377-84.

The equalization of a GSM data signal with the aid of a training sequence comprising 26 bits is described in the article entitled “Prediction of GSM Performance Using Measured Propagation Data”, by R. M. Joyce et al., Vehicular Technology Conference, 1996, Mobile Technology for the Human Race, IEEE 46^{th} Atlanta, Ga., USA, 28 April to May 1, 1996, New York, N.Y., USA, IEEE, US, Apr. 28, 1996, pages 326-30. Five channel parameters are calculated for the equalization.

### SUMMARY OF THE INVENTION

It is accordingly an object of the invention to provide a method and a device for improved channel equalization which overcomes the above-mentioned disadvantages of the heretofore-known devices and methods of this general type and which provides a receiver unit for mobile radio transmission and a method for equalizing data symbols transmitted via a mobile radio channel which permit a reduction in the bit error rate in conjunction with an unchanged transmission power. It is, in particular, the object of the invention to reduce the contribution to the bit error rate caused by intersymbol interference (ISI).

With the foregoing and other objects in view there is provided, in accordance with the invention, a receiver unit for mobile radio transmission, comprising:

a channel estimator for determining first 6 channel coefficients for modeling a transmission channel by correlating received data symbols with a training sequence comprising 26 data symbols;

a channel equalizer for equalizing the received data symbols with reference to the channel coefficients determined by the channel estimator;

wherein the channel estimator, in addition to the first 6 channel coefficients, determines at least one further channel coefficient, and wherein, in the determination of the at least one further channel coefficient, the received data symbols used for correlating with the training sequence contain at least one fewer received data symbol of the training sequence than in the determination of the first 6 channel coefficients; and

wherein the channel equalizer is configured for equalizing the received data symbols using more than 6 channel coefficients.

With the above and other objects in view there is also provided, in accordance with the invention, a method with improved channel equalization. The method comprises the following steps: inputting received data symbols;

determining 6 channel coefficients and at least one further channel coefficient by correlating the received data symbols with a training sequence comprising 26 data symbols, for modeling the transmission channel, the received data symbols used for the correlation with the training sequence containing, in the determination of the at least one further channel coefficient, at least one fewer received data symbol of the training sequence than in the determination of the first 6 channel coefficients; and

equalizing the received data symbols by using the 6 channel coefficients and the at least one further channel coefficient.

In other words, the receiver unit according to the invention for mobile radio transmission comprises a channel estimator that determines channel coefficients for modeling the transmission channel by correlating the received data symbols with a training sequence consisting of 26 data symbols, and a channel equalizer that equalizes the received data symbols by using the channel coefficients determined by the channel estimator. The channel estimator determines at least one further channel coefficient in addition to the first six channel coefficients (h₀, h₁, . . . h₅). When determining the at least one further channel coefficient, the received data symbols used for correlation with the training sequence contain at least one fewer received data symbol of the training sequence than in the determination of the first 6 channel coefficients. The received data symbols are then equalized by the channel equalizer by using more than six channel coefficients.

In the solutions of the prior art, the channel response was modeled in each case with the aid of four, five, or at most six channel coefficients h₀, . . . . h₅. Thus (L+1)≦6 was set respectively for the channel length (L+1). The following three considerations opposed more accurate modeling of the channel response with the aid of further channel coefficients.

A) The most important contributions to the intersymbol interference are already detected by the first six channel coefficients. The general assumption was made that taking account of the channel coefficients h₆, h₇ etc., which are small in absolute value, effects only a negligible improvement, possibly even a worsening of the channel equalization.

B. The computational outlay in channel equalization rises exponentially with the channel length (L+1), specifically with 2^{L+1} for GSM. The reason for this is that because of the improved channel memory L both the number of the precursor states and the number of the target states increase in the case of the trellis-based sequence estimation. Consequently, taking account of additional channel coefficients leads to an increased computational outlay.

C. In the GSM standard, each data burst comprises a training sequence whose training symbols are known at the receiving end. This training sequence is designed in the GSM standard such that it is possible therewith to determine at most six channel coefficients h₀, . . . . h₅. In order to determine the seventh and further channel coefficients, the training sequence must be used otherwise than originally intended. It is certainly possible to use the training sequence to determine further channel coefficients, but these channel coefficients then are highly defective. It was generally assumed that taking account of highly defective channel coefficients in the equalization worsens the bit error rate rather than improving it.

It has emerged that for EDGE and under HT (Hilly Terrain) transmission conditions, taking account of the seventh and further channel coefficients can significantly reduce the bit error rate despite the error that must be accepted in determining these channel coefficients. A prescribed bit error rate of, for example, 10⁻³ can be achieved with a transmit power that is less by 2 to 3 dB.

This unexpectedly strong influence of the defective seventh channel coefficient, which is low in absolute value, can be explained by virtue of the fact that the channel equalization is based on an improved channel model. This permits a better analysis and decoding of the distorted signal. Taking account of the seventh and further channel coefficients seems in many instances to be the factor tipping the scales for a successful sequence estimation.

It is advantageous when the channel equalizer is a trellis-based channel equalizer that equalizes the received data symbols by means of the Viterbi method. In the case of equalization with the aid of the Viterbi method, it is not the individual received data symbol, but the total symbol sequence that is estimated (sequence estimation). For this purpose, the metrics of different paths through the trellis diagram are determined and intercompared. The symbol sequence obtained as a result of the Viterbi method constitutes the cost-minimized path through the trellis diagram. The transmitted data symbols can be reconstructed with a high probability of detection with the aid of a trellis-based channel equalizer. A trellis-based equalizer that uses more than six channel coefficients constitutes the best known equalizer to date.

The undistorted sequence of training symbols is known at the receiver end. Because of the multipath propagation characteristic, a plurality of differentially delayed signal components contribute to the received signal. The received, distorted signal is therefore a superimposition of various differentially delayed undistorted signal components. The contributions of the individual signal components can be determined by correlation with the undistorted signal. The channel coefficients can then be derived directly from the various correlation values.

A training sequence with a length of 26 symbols is used in the GSM standard. In order to determine the channel coefficient ho, a correlation is carried out between the middle 16 symbols of the undistorted training sequence and a received training sequence comprising 16 symbols. Subsequently, the correlation analysis is repeated with the sequence of received training symbols that is shifted to the right by one symbol position, in order to obtain the channel coefficient h₁. The further channel coefficients can also be determined by further rightward shifts of the received training sequence and subsequent correlation analysis. The channel coefficients h₀, . . . h₅ can be determined without error with the aid of a training sequence comprising 26 symbols. During the determination of the seventh and all following channel coefficients, the received training sequence still overlaps with the undistorted sequence of training symbols only in part. To this extent, errors are produced in the determination of the channel coefficients h₆, h₇, . . . . Despite these errors, the sequence estimation is, however, improved by taking account of these further channel coefficients. To this extent, taking account of additional channel coefficients in the way according to the invention is advantageous even in the case of the 26 symbol training sequence of the GSM standard.

In accordance with a further advantageous embodiment of the invention, the transmission channel is a hilly terrain channel. In the case of mobile radio transmission in hilly and mountainous regions, pronounced intersymbol interference occurs because of the multiplicity of signal paths. Since the received signal also contains relevant contributions of greatly delayed signal components, it is particularly important in the case of the hilly terrain channel also to take account of the channel coefficients of higher order. Taking account of the seventh and possibly also further channel coefficients therefore improves the basic channel model, particularly in the case of hilly terrain channels, and therefore clearly lowers the bit error rate.

In addition to the first six channel coefficients, it is particularly advantageous to determine a seventh channel coefficient and use it in the channel equalization. The bit error rate can already be significantly lowered by taking account of the seventh channel coefficient.

In accordance with a further advantageous embodiment of the invention, the channel estimator and the channel equalizer process 8-PSK modulated data symbols. Because of the slight phase difference of 45° between the individual signal points of the signal space, the 8-PSK modulation is substantially more strongly disturbed by inadequate modeling of the channel response than is the relatively robust GMSK modulation. In the case of the 8-PSK modulation, defective channel estimation leads immediately to a rise in the bit error rate. Conversely, taking account of additional channel coefficients refines the channel model and it is thereby possible for the individual phase states to be identified more effectively. Consequently, more accurate channel modeling is advantageous in the case of the 8-PSK modulation, in particular.

It is advantageous, in particular, when the channel estimator and the channel equalizer process data symbols in the EDGE standard. This subsequent GSM standard uses the 8-PSK modulation. The signal-to-noise ratio is relatively high and so the noise moves increasingly into the background. It is important for these two reasons to remove the intersymbol interference by effective equalization.

Other features which are considered as characteristic for the invention are set forth in the appended claims.

Although the invention is illustrated and described herein as embodied in an improved channel equalization for mobile radio receivers, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic illustrating how the channel response can be modeled with the aid of channel coefficients;

FIG. 2 is a diagram of a mobile radio receiver that comprises a channel estimator and a channel equalizer;

FIG. 3 is a structure diagram of a received data burst that has a training sequence; and

FIG. 4 is a diagram showing the determination of the channel coefficients h₀, . . . h₆ with the aid of correlation properties of the training sequence.

### DESCRIPTION OF THE PREFERRED EMBODIMENTS

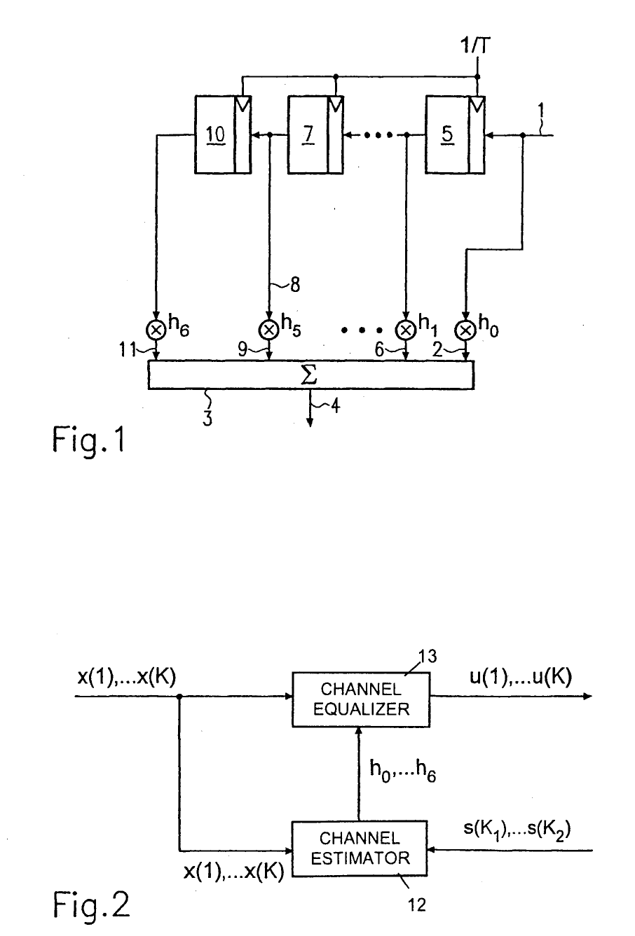

Referring now to the figures of the drawing in detail and first, particularly, to FIG. 1 thereof, there is shown how the response of a mobile radio channel can be described by a set of channel coefficients h₀, . . . h_{L}. In this case, L denotes the channel memory.

During mobile radio transmission, a transmitted signal reaches the receiver via various propagation paths. For example, the receiver could receive a first signal component directly from the transmitter, while a second signal component reaches the receiver after reflection at a building wall. The second signal component would thus arrive at the receiver with a delay by comparison to the first signal component, and the received signal would consist of the superimposed first and second signal components. Moreover, further signal components, differentially delayed, can contribute to the received signal, the aggregate signal being composed of the superimposition of the signal components differentially delayed by the various paths. The so-called intersymbol interference (ISI) is thus caused by the multipath signal propagation.

A model for simulating the transmission properties of a channel with the aid of channel coefficients is shown in FIG. 1. The input signal 1 corresponds in this case to the transmitted signal and has no intersymbol interference. The input signal 1 is multiplied by the first channel coefficient ho and thus supplies the signal component 2 of least delay. This signal component 2 is fed to the adder 3 and contributes to the superimposed signal 4.

In order to obtain the second signal component 6, the input signal 1 is delayed by a first time-delay element 5 by the data symbol duration T. The period T is determined by the sampling frequency f_{sampling}:

$$T = \frac{1}{{f}_{sampling}}$$

Subsequently, the delayed signal is multiplied by the second channel coefficient h₁. This second signal component 6 is also fed to the adder 3 and contributes to the superimposed signal 4. The fivefold delayed input signal 8, which is multiplied by the channel coefficient h₅ in order to supply the sixth signal component 9, can be tapped at the fifth time-delay element 7.

A seventh channel coefficient h₆ is now provided in addition to the channel coefficients h₀ to h₅ in the solution according to the invention in order to model the channel response.

Consequently, an additional seventh signal component 11 can be taken into account when forming the superimposed signal 4. The additional delay T of the signal component 11 with respect to the signal component 9 is caused by the time-delay element 10.

The superimposed signal 4 can be represented according to this channel model as

$${\sum }_{i = 0}^{6} {h}_{i} \cdot s ( k - i ) ,$$

where s(1), . . . s(K) designate the undistorted data symbols.

The modified channel model according to the invention leads to an improved decoding of the received signal particularly when greatly delayed signal components contribute to the aggregate signal. Multipath signal propagation of such a pronounced nature is to be expected, for example, in hilly and mountainous radio areas, and the invention is therefore suitable, in particular, for use with hilly terrain channels.

FIG. 2 shows the block diagram of a mobile radio receiver according to the invention. The received sequence of data symbols x(1), . . . x(K) of a data burst is fed both to the channel estimator 12 and to the channel equalizer 13. The task of the channel estimator 12 is to use the training sequence to estimate the distortion effected by the channel, and thus to determine the channel coefficients h₀ to h₆ of the channel model shown in FIG. 1. The determination of the channel coefficients h₀, . . . h₆ is performed by correlating the distorted training sequence x(K₁), . . . x(K₂) with the undistorted training sequence s (K₁), . . . s (K₂) known at the receiving end.

The determined channel coefficients h₀, . . . h₆ are fed to the channel equalizer 13, which carries out equalization of the received data symbols x(1), . . . x(K). The channel equalizer can be a trellis-based channel equalizer that carries out sequence estimation of the received data symbols on the basis of the Viterbi algorithm in order thus to obtain the equalized data symbols u(1), . . . u(K).

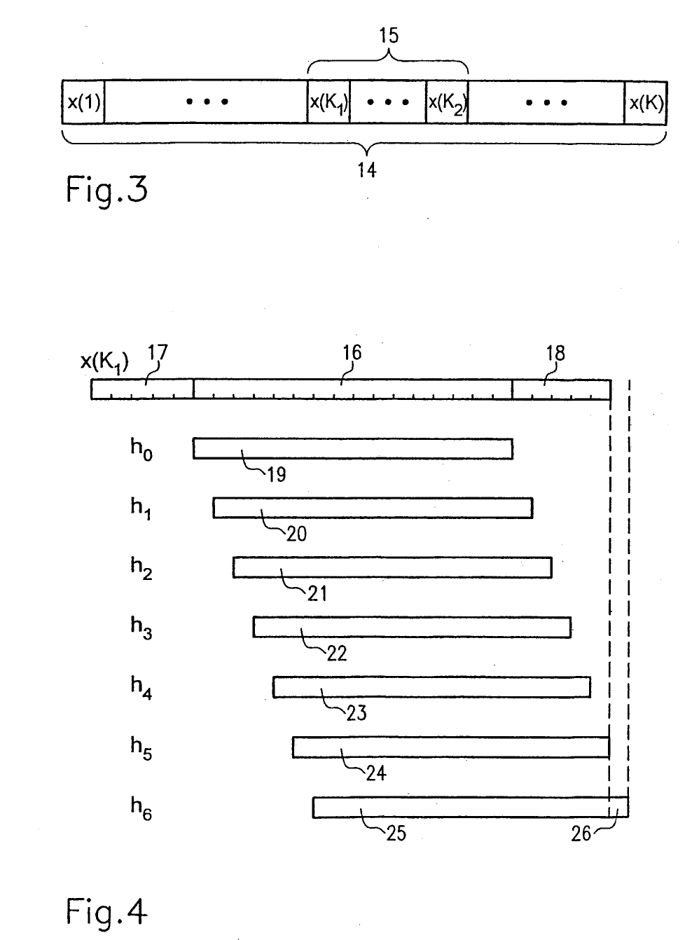

FIG. 3 shows the structure of a received data burst 14 that comprises the data symbols x(1), . . . x(K). The training sequence is transmitted as midamble in the GSM standard, and this means that the training symbols of the training sequence are transmitted starting from the K₁-th data symbol up to, and including, the K₂-th data symbol. Correspondingly, the received data burst 14 comprises the distorted training sequence 15 with the data symbols x(K₁), . . . x(K₂). However, this means that both the previously known, undistorted training sequence s(K₁), . . . s(K₂) and the distorted training sequence 15 with the data symbols x(K₁), . . . x(K₂) are available to the channel estimator at the receiving end. By comparing the distorted and the undistorted sequences of data symbols, the channel estimator 12 can determine wherein way the mobile radio channel distorts the transmitted data symbols.

FIG. 4 shows how the channel coefficients h₀, . . . . h₆ are determined by correlation of the distorted training sequence x(K₁), . . . x(K₂) with the undistorted training sequence s(K₁), . . . s(K₂). The training sequence comprises 26 data symbols in the GSM standard. The middle section 16 of the training sequence, which is used for the actual correlation calculation, comprises 16 data symbols. The front section 17 and the rear section 18 each comprise 5 symbols.

In order to determine the first channel coefficient ho, the correlation of the middle section 16 of the distorted training sequence and the undistorted training sequence 19 is calculated. Each data symbol can assume the values −1 and +1 in the GSM standard. The correlation of the two sequences, whose maximum value is +16 (for the case of identity of the two sequences) is obtained by bitwise multiplication and adding up. The correlation value determined is proportional to ho and can be converted directly into h₀. Subsequently, the correlation between the undistorted training sequence 20 right-shifted by one symbol position and the distorted training sequence is calculated. Thus, the correlation of the undistorted training symbols s(K₁+5), . . . s(K₂−5) with the distorted training symbols x(K₁+6), . . . x(K₂−4) is determined. The right shifting by one symbol position corresponds to a delay by one data symbol duration T.

The channel coefficient h₁ can be obtained directly from the correlation result.

The channel coefficient h₂ can be obtained by correlating the undistorted training sequence 21 right-shifted by two symbol positions with the received training symbols x(K₁+7), . . . x(K₂−3). Two data symbols of the rear section 18 of the distorted training sequence, specifically the data symbols x(K₂'4) and x(K₂−3), are also used in carrying out this correlation. This rear section 18 of the training sequence is provided for the purpose of permitting error-free calculation of the correlation. Data symbols containing the useful information do not begin until after this rear section 18 of the training sequence, that is to say starting from the data symbol x(K₂+1).

The channel coefficients h₃, h₄ and h₅ are determined in a corresponding way by correlation of the undistorted training sequences 22, 23, 24, right-shifted by further symbol positions, with data symbols of the middle section 16 and of the rear section 18 of the received training sequence. Exclusive use is made of data symbols of the training sequence in this case in order to calculate the correlation.

In the calculation according to the invention of the seventh channel coefficient h₆, the undistorted training sequence 25 must be right-shifted with respect to the received training sequence by exactly 6 symbol positions, and this corresponds to a delay by six data symbol durations T. As may be seen from FIG. 4, the correlation calculation can, however, no longer be carried out completely within the training sequence.

The correlation with the received data symbols of the middle section 16 and of the rear section 18 is carried out with regard to the first 15 symbols of the undistorted training sequence 25. With regard to the last training symbol 26, the correlation must, however, already be carried out with the first data symbol that represents useful data. The rear section 18 of the training sequence is not long enough in the GSM standard in order to be able to carry out the correlation for the purpose of determining the seventh channel coefficient completely within the training sequence. The first data symbol belonging to the useful data sequence can assume any desired value, and to this extent the correlation contribution of the training symbol 26 causes an error.

The training sequence of the GSM standard is designed for determining at most six channel coefficients. Whereas the channel coefficients h₀, . . . . h₅ can be determined with high accuracy, it is necessary to accept a substantial error in the case of the additional channel coefficients h₆, h₇, etc., which are mostly very small in absolute value, because of the overlap with parts of the useful sequence.

It may be seen from FIG. 2 that the channel coefficients determined by the channel estimator 12 are fed to the channel equalizer 13, which appropriately equalizes the received data symbols x(1), . . . x(K) in accordance with the channel model prescribed by h₀, . . . h_{L}, and thus supplies the sequence of equalized data symbols u(1), . . . u(K). For this purpose, a channel estimation of the received symbols is carried out on the basis of the Viterbi algorithm. State transitions from 2^{L} precursor states to 2^{L} target states are considered in each case when calculating the costs of different paths through the trellis diagram. During a state transition, a new data symbol that has two states (GMSK modulation) or eight states (8-PSK modulation) is respectively added to the path. The total computational outlay for the channel estimation is proportional to 2^{L+1} (in the case of GMSK modulation) or proportional to 8^{L+1} (in the case of 8-PSK modulation). It follows from this that the increase in the number of the channel coefficients from six to seven leads to a doubling of the computational outlay in the case of GMSK and an eightfold increase in the case of 8-PSK in the channel equalization. Because of the continuous increase in processor power, this extra outlay can, however, be accepted in view of the greatly reduced bit error rate. A prescribed bit error rate can already be ensured with a transmit power lowered by 2 to 3 dB.

We claim:

1. A receiver unit for mobile radio transmission, comprising:
a channel estimator for determining first 6 channel coefficients for modeling a transmission channel by correlating received data symbols with a training sequence comprising 26 data symbols;
a channel equalizer for equalizing the received data symbols with reference to the channel coefficients determined by the channel estimator;
wherein said channel estimator, in addition to the first 6 channel coefficients, determines at least one further channel coefficient, and wherein, in the determination of the at least one further channel coefficient, the received data symbols used for correlating with the training sequence contain at least one fewer received data symbol of the training sequence than in the determination of the first 6 channel coefficients; and
wherein said channel equalizer is configured for equalizing the received data symbols using more than 6 channel coefficients.

2. The receiver unit according to claim 1, wherein said channel equalizer is a trellis-based channel equalizer configured to equalize the received data symbols according to the Viterbi method.

3. The receiver unit according to claim 1, wherein the transmission channel is a hilly terrain channel.

4. The receiver unit according to claim 1, wherein said channel estimator is configured for determining a seventh channel coefficient in addition to the first 6 channel coefficients, and said channel equalizer is configured for equalizing the received data symbols by using 7 channel coefficients.

5. The receiver unit according to claim 1, wherein said channel estimator and said channel equalizer are configured for processing 8-PSK modulated data symbols.

6. The receiver unit according to claim 1, wherein said channel estimator and said channel equalizer are configured for processing data symbols in the EDGE standard.

7. A method for equalizing data symbols transmitted via a mobile radio channel, which comprises the following method steps:
inputting received data symbols;
determining 6 channel coefficients and at least one further channel coefficient by correlating the received data symbols with a training sequence comprising 26 data symbols, for modeling the transmission channel, the received data symbols used for the correlation with the training sequence containing, in the determination of the at least one further channel coefficient, at least one fewer received data symbol of the training sequence than in the determination of the first 6 channel coefficients; and
equalizing the received data symbols by using the 6 channel coefficients and the at least one further channel coefficient.

8. The method according to claim 7, which comprises equalizing the received data symbols with a trellis-based channel equalizer using the Viterbi method.

9. The method according to claim 7, which comprises determining the 6 channel coefficients and the at least one further channel coefficient for modeling the transmission channel with a channel estimator by correlating the received data symbols with a training sequence.

10. The method according to claim 7, wherein the transmission channel is a hilly terrain channel.

11. The method according to claim 7, which comprises determining exactly 7 channel coefficients.

12. The method according to claim 7, which comprises processing the received data symbols in accordance with the 8-PSK standard.

13. The method according to claim 7, which comprises processing the received data symbols in accordance with the EDGE standard.
